(19) United States
(12) Patent Application Publication
(10) Pub. No.: US 2022/0003206 A1
(43) Pub. Date: Jan. 6, 2022

(54) WIND ENERGY INSTALLATION AND A METHOD OF OPERATING A WIND ENERGY INSTALLATION

(71) Applicant: Siemens Gamesa Renewable Energy Service GmbH, Hamburg (DE)

(72) Inventors: Oliver Hör, Bredenbek (DE); Stefan Behl, Neumünster (DE); Karsten Warfen, Weede/Sohren (DE)

(21) Appl. No.: 17/366,696

(22) Filed: Jul. 2, 2021

(30) Foreign Application Priority Data
Jul. 3, 2020 (DE) 10 2020 004 034.9
Jul. 3, 2020 (DE) 10 2020 004 035.7

(51) Int. Cl. F03D 7/02

(52) U.S. Cl. CPC F03D 7/0224; F05B 2260/79; F05B 2260/76; F03D 7/0264

(57) ABSTRACT

A wind energy installation includes a rotor with a first rotor blade that is angularly adjustable, a first adjustment drive for adjusting the first rotor blade, a safety control device/system, a first reversing device for supplying energy to the first adjustment drive from an energy source via the first reversing device to adjust the first rotor blade in a first direction and to adjust the first rotor blade in a second direction opposite to the first direction. A second reversing device can be switched over by the safety control device/system for supplying energy to the first adjustment drive from an energy storage device in a first special mode of operation via the second reversing device in a first switching position to adjust the first rotor blade in the first direction and in a second switching position to adjust the first rotor blade in the second direction.

### CROSS-REFERENCE TO RELATED APPLICATIONS

This application claims the benefit of priority under 35 U.S.C. § 119(a) to German Patent Application Nos. DE 10 2020 004 034.9, filed Jul. 3, 2020 (pending), DE 10 2020 004 035.7, filed Jul. 3, 2020 (pending), and DE 10 2020 004 036.5, filed Jul. 3, 2020 (pending), the disclosures of which are hereby incorporated by reference in their entirety.

### TECHNICAL FIELD

The present invention relates to a wind energy installation, a method of operating a wind energy installation, as well as a computer program product for carrying out the method.

### BACKGROUND

Wind energy installations with rotor blades which can be adjusted in terms of their angle are known from internal practice within the present applicant company.

By adjusting the rotor blades to a feathered position, in which they, at least substantially, do not generate any power at a rotor axis of rotation or at a rotor hub, in particular a power of the wind energy installation can be controlled and/or a load can be reduced in case of (too) strong wind.

In normal operation, adjustment drives for adjusting the rotor blades are supplied with (drive) energy from a source of energy, for example electromotive adjustment drives are supplied with (drive) energy from an (electricity) grid, or hydraulic adjustment drives are supplied with (drive) energy from a hydraulic system.

In the event of a failure of this primary power supply, it is known from internal practice within the present applicant company, in a special mode of operation, to connect adjustment drives to an energy storage device instead, for example to connect electromotive adjustment drives to a rechargeable battery, or to connect hydraulic adjustment drives to a (hydraulic) pressure storage device, so that they are turned to the feathered position in an uncontrolled manner, but in a manner which is safe. When the feathered position has been reached, this power supply from the energy storage device is switched off or interrupted, for example by a contactor in the case of electromotive adjustment drives or by an automatic switching valve in the case of hydraulic adjustment drives. In the case of hydraulic adjustment cylinders as the drive, the feathered position can also be limited by a mechanical end stop.

In this way, in the event of a failure of the power supply from the source of energy, the rotor blades can be turned to their feathered position in a simple and thus reliable manner, and in particular this adjustment can (reliably) be terminated there.

### SUMMARY

It is an object of the present invention to improve the operation of a wind energy installation.

This object is solved by a method, a wind energy installation, and a computer program product for carrying out a method described herein.

According to one embodiment of the present invention, a wind energy installation comprises a rotor with at least one rotor blade which can be adjusted in terms of its angle, and which, without loss of generality, is referred to herein as the first rotor blade, and an adjustment drive (which, in a corresponding manner, is referred to as the first adjustment drive), with the aid of which this rotor blade can be adjusted (in terms of its angle) or is adjusted (in terms of its angle) or is provided for this purpose, or is in particular set up for this purpose or is used for this purpose, in particular by means of which this rotor blade can be adjusted (in terms of its angle) or is adjusted (in terms of its angle) or is provided for this purpose, or is in particular set up for this purpose or is used for this purpose.

According to one embodiment, the rotor is mounted on a nacelle of the wind energy installation so as to be able to rotate about a rotor axis of rotation, in particular a horizontal rotor axis of rotation, and according to one embodiment it is coupled to a generator for converting a rotation of the rotor or a power of the rotor into electrical energy, in particular for feeding into a grid (or a power supply grid or an electricity grid). According to one embodiment, the nacelle is arranged on a tower and, according to one embodiment, it is able to be rotated, by means of a nacelle drive, about a vertical nacelle axis of rotation. According to one embodiment, the rotor comprises a plurality of rotor blades which can be adjusted in terms of their angle, according to one embodiment three rotor blades which can be adjusted in terms of their angle, and which, according to one embodiment, are distributed along a circumference of the rotor (or are arranged in a distributed manner along a circumference of the rotor).

Without being limited thereto, the present invention is particularly suitable for such wind energy installations, in particular because of the loads and operating conditions encountered in connection with these.

According to one embodiment, one or more rotor blades of the rotor, in particular all rotor blades of the rotor can (each) be adjusted (in terms of their angle) by means of their own adjustment drive.

According to one embodiment, by means of this, the blade pitch can be adjusted individually, and thereby the safety can be increased and/or the power control of the wind energy installation can be improved.

In the present application, an adjustment of a rotor blade (in terms of its angle) is intended to be understood to refer in particular to a rotation of the rotor blade about a rotor blade axis of rotation which extends in the longitudinal direction of the rotor blade and/or transverse to the rotor axis of rotation. In so far as an adjustment or a position is mentioned in the present application, this can be (respectively) a rotation or an angular position or an angular orientation about the rotor blade axis of rotation.

According to one embodiment of the present invention, the wind energy installation comprises a safety control device/system. According to one embodiment, this has full or partial redundancy; according to one embodiment, it has full or partial diversity; and according to one embodiment, it comprises at least one safety logic controller (SLC). According to one embodiment, the SLC is a safety control device/system according to IEC 61508/IEC61511 with safety integrity level (SIL) SIL2 or SIL3, which according to one embodiment is arranged in the rotor hub of the wind energy installation.

By means of this, according to one embodiment, despite the departure from known safety concepts explained below, their safety standard or safety level can be realized.

According to one embodiment of the present invention, the wind energy installation comprises a first reversing device via which the first adjustment drive
is supplied, at least temporarily, with (drive) energy from a source of energy in such a way that (in a first condition of the first reversing device) it adjusts the first rotor blade in a first direction; and
is supplied, at least temporarily, with (drive) energy from a source of energy in such a way that (in a second condition of the first reversing device) it adjusts the first rotor blade in a second direction which is opposite to the first direction,
   or the first reversing device is provided in this way or is provided for this purpose, in particular the first reversing device is set up in this way or is set up for this purpose, or the first reversing device is used for this purpose.

According to one embodiment, this first reversing device comprises one or more converters and/or one or more switching valves.

In this way, according to one embodiment, in a normal mode of operation, the rotor blade can be adjusted in terms of its angle, and, by means of this, a power output of the wind energy installation can be controlled and/or a load can be reduced in case of (too) strong wind.

According to one embodiment of the present invention, the wind energy installation comprises a second reversing device which can be switched, or is switched, by means of the safety control device/system into a first switching position and a second switching position and via which the first adjustment drive, in at least one special mode of operation, which, without loss of generality, is referred to herein as the first special mode of operation,
is supplied, at least temporarily, with (drive) energy from an energy storage device (which is different from the source of energy), in such a way that, in the first switching position of the second reversing device, it adjusts the first rotor blade in the first direction; and
is supplied, at least temporarily, with (drive) energy from an energy storage device (which is different from the source of energy), in such a way that, in the second switching position of the second reversing device, it adjusts the first rotor blade in the second direction,
   or the second reversing device is provided in this way or is provided for this purpose, in particular the second reversing device is set up in this way or is set up for this purpose, or the second reversing device is used for this purpose.

According to one embodiment, the second reversing device, in particular for this purpose and/or for realizing the first or the second (adjustment) direction, connects a first input to a first output as well as a second input to a second output in the first switching position, and it connects the first input to the second output as well as the second input to the first output in a second switching position, or is provided for this purpose, or is in particular set up for this purpose or is used for this purpose. According to one embodiment, by means of this, a simple and/or a reliable reversal of the direction of adjustment can be realized.

This is based on a deliberate departure from previous safety concepts, which provide for a single, fixed direction of adjustment in a special mode of operation, in which the adjustment drive is not supplied with energy regularly via the first reversing device but (directly) via the second reversing device and, by means of this, is adjusted (in an uncontrolled manner) in the fixed direction of adjustment all the way to a stopping position in which this adjustment is then interrupted by interrupting the supply of energy via the second connection.

In return, by means of the present invention, which realizes a “polarity reversal”, as it were, of the (direct) supply of energy from the energy storage device via the second reversing device, it becomes possible for the first time to adjust the rotor blade in two opposite directions even in the event of a malfunction of the supply of energy via the first reversing device, in particular (also) in the event of a (functional) malfunction of the first reversing device itself, i. e., for example, of a converter, a switching valve or a (pitch) controller controlling the same.

According to one embodiment, by means of this, a (possibly restricted) mode of operation of the wind energy installation in which the wind energy installation generates energy, in particular a (possibly restricted) mode of operation of the wind energy installation in which the wind energy installation performs a feed-in of energy, can be maintained even in the event of such a malfunction, in particular a (possibly restricted) adaptation of the rotor blade position to different ambient conditions, in particular wind speeds, can be carried out with the aid of the second reversing device, and, in the event of the wind becoming weaker, the rotor blade can in particular be (re)adjusted from a position in which it generates less lift and/or less power at the rotor to a position in which it generates more lift and/or more power at the rotor.

This is of great advantage in particular if a repair of the malfunction is delayed, in particular in the case of offshore wind energy installations.

In addition or as an alternative, according to one embodiment, by means of this, a rotor blade that, in the first special mode of operation, has moved to a stopping position, in particular to a feathered position, and which, despite a pitch brake being closed, continues to slip in this position in the direction in which it has approached this position, can be brought back again to the stopping position after the reversal of the direction of adjustment.

According to one embodiment, the energy storage device is located in the wind energy installation, and according to one embodiment, the energy storage device is located in the rotor or in the nacelle.

According to one embodiment, by means of this, the safety can be improved.

According to one embodiment, the wind energy installation has one or more switching off device(s) for interrupting the supply of energy to the first adjustment drive via the second reversing device, wherein, in a further development, the switching off device or (each of the) one or more of the switching off devices are controlled by the safety control device/system, or the switching off device and the safety control device/system are set up for this purpose or are used for this purpose. According to one embodiment, the switching off device or (each of the) one or more of the switching off devices interrupts or interrupt the supply of energy to the first adjustment drive via the second reversing device as a result of the first rotor blade reaching a predefined stopping position or a predefined stopping region, according to one embodiment a switching off device interrupts the supply of energy to the first adjustment drive via the second reversing device as a result of a feathered position or a stopping region around the feathered position having been reached, and/or a switching off device interrupts the supply of energy to the first adjustment drive via the second reversing device as a result of a spinning position, which deviates from the feathered position by at most 15 degrees, in particular by at most 10 degrees, or a stopping region around the spinning position, having been reached.

According to one embodiment, by means of this, with the second reversing device being switched into the first switching position, the safety concept which is already known per se can continue to be realized and thus the rotor blade can be adjusted in the opposite direction via the first reversing device with at least a similar safety level even in the event of a malfunction in the power supply. In addition or as an alternative, by controlling the switching off device(s) by means of the safety control device/system, the latter can adjust the rotor blade in the desired direction of adjustment in a targeted manner, in particular alternately in the first direction and the second direction and/or in the first direction in a stepwise manner and/or in the second direction in a stepwise manner, and/or a load in connection with a switching on and/or switching off of the second reversing device can be reduced by switching it over (only) when the power supply is interrupted by means of a switching off device and/or, conversely, a load in connection with a switching on and/or switching off of the second reversing device can be reduced by establishing or activating the power supply by a deactivation device (or by closing a deactivation device) (only) after the second reversing device has been switched over.

According to one embodiment, the wind energy installation comprises a time delay device, according to one embodiment one or more time relays (or time switching relays) or the like, which cause at least a predetermined waiting time between a detection of a predetermined position of the first rotor blade and the interruption of the supply of energy by means of the switching off device associated with the time delay device, or by means of a switching off device associated with the time delay device.

According to one embodiment, this makes it possible for the rotor blade to be positioned, in an advantageous manner, inside a stopping region when an approach is made from opposite directions, and for the supply of energy to the first adjustment drive to be interrupted as a result of a detection of the reaching of this stopping region: if the rotor blade approaches the stopping region in the first direction, reaching an end of the stopping region which end is located at a foremost position in the first direction is detected. If, in contrast to this, the rotor blade approaches the stopping region in the second direction, reaching an end of the stopping region which end is located at a foremost position in the second direction is detected. Due to the time delay or the waiting time, the rotor blade is, in each case, moved further in the direction of the approach and thus, in each case, is moved further into the interior of the stopping region, so that, in an advantageous manner, it can then slip a little in this region, in particular with the pitch brake (then) being closed, without leaving the stopping region and thus unintentionally deactivating the switching off device or causing a renewed adjustment with power supply via the second reversing device.

According to one embodiment, the wind energy installation comprises one or more lines for supplying energy to the first adjustment drive from the energy storage device via the first reversing device in at least one further special mode of operation.

In this way, the first reversing device can be used, according to one embodiment primarily or in a prioritized manner, (also) in order to specify the direction of adjustment even in the event that energy is being supplied from the energy storage device, and the second reversing device can be resorted to (only) if required, in particular in the event that there is a malfunction in the function of the first reversing device.

According to one embodiment, by means of this, additional safety and/or better controllability (by the first reversing device) is provided in an advantageous manner. In a corresponding manner, according to one embodiment, the supply of energy from the energy storage device is carried out alternatively
according to one embodiment in a preferential or prioritized manner, indirectly via the first reversing device, in particular (only and/or always) if this is functional, and accordingly not via the second reversing device; or
directly via the second reversing device, in particular (only and/or always) if the first reversing device is not functional, and accordingly then not (also) via the first reversing device.

According to one embodiment, the wind energy installation has a pitch brake for holding the first rotor blade in a current position and a detection device, according to one embodiment one or more sensors, for detecting a deviation between a current position of the first rotor blade and a predefined target position, wherein the safety control device/system adjusts the first rotor blade in the direction of the target position with the aid of the first adjustment drive supplied with energy from the energy storage device via the second reversing device if the deviation exceeds a predefined threshold value, or is provided for this purpose, or is in particular set up for this purpose or is used for this purpose.

Thus, according to one embodiment, in the first special mode of operation, a pitch brake is secured by the first adjustment drive which is supplied with energy from the energy storage device via the second reversing device, which first adjustment drive intervenes in the event of slipping (through) of the pitch brake and returns the rotor blade to the target position.

According to one embodiment, the pitch brake slips, according to plan, at a load acting on the rotor blade which is smaller than a maximum load which acts on the rotor blade in the feathered position and for which the wind energy installation is constructed, and according to one embodiment, the pitch brake is constructed accordingly or in such a way, in particular dimensioned accordingly or in such a way. According to one embodiment, this load or the maximum load comprises a torque (or a maximum design torque) about the rotor blade axis of rotation.

According to previous safety concepts, the pitch brake must be able to hold the rotor blade on its own, and reliably, in its feathered position, even when a maximum load acts on the rotor blade which has been assumed in the course of the design of the wind energy installation or on which the design of the wind energy installation has been based or which was expected in the course of the design of the wind energy installation.

In contrast to this, according to one embodiment of the present invention, a slipping of the rotor blade at high load, which rotor blade is held in a current position by means of the pitch brake, in particular at least at a maximum load on the rotor blade which was assumed in the course of the design of the wind energy installation to occur in the feathered position, is deliberately accepted and in this case limited, preferably compensated for, by adjusting the rotor blade with the aid of its adjustment drive by means of supply of energy to the adjustment drive from the energy storage device.

This can be of particular advantage in particular if, in particular for safety reasons, the adjustment drive and/or the energy storage device are designed for adjusting the rotor blade to the feathered position even when the pitch brake is closed, since in this case a deliberately weaker design of the pitch brake makes a correspondingly more favorable construction of the adjustment drive and/or of the energy storage device possible.

According to one embodiment, the first adjustment drive comprises at least one electric motor, according to one embodiment at least one DC motor, and the energy storage device comprises at least one electrical energy storage device, in particular a rechargeable battery. In this case, according to one embodiment, the first reversing device comprises at least one converter, according to one embodiment at least one converter which is controlled by a (pitch) controller. In addition or as an alternative, according to one embodiment, the second reversing device comprises at least one contactor, in particular for reversing the polarity of the first and second inputs and outputs. In addition or as an alternative, according to one embodiment, the switching off device or at least one of the switching off devices comprises at least one contactor for interrupting the supply of energy to the first adjustment drive via the second reversing device.

In particular due to the possibilities of failure of electrical rotor blade adjustment devices/systems, the present invention can be used to particular advantage for this purpose. In this context, in particular a reversal of polarity of a direct supply of energy of a DC motor from the energy storage device can be especially advantageous, since it combines the advantages of the latter with the possibility of adjusting in opposite directions in the first special mode of operation, using the latter.

According to one embodiment, the first adjustment drive comprises at least one hydraulic actuator, in particular at least one hydraulic cylinder, and the energy storage device comprises at least one (hydraulic) pressure accumulator, in particular at least one hydropneumatic pressure accumulator or a hydraulic pressure accumulator. In this case, according to one embodiment, the first reversing device comprises one or more switching valves, and, in this case, according to one embodiment, the first reversing device comprises one or more switching valves which are controlled by means of a (pitch) controller. In addition or as an alternative, according to one embodiment, the second reversing device comprises one or more switching valves, in particular for reversing the polarity of the first and second inputs and outputs or the flow direction(s) through the hydraulic adjustment drive. In addition or as an alternative, according to one embodiment, the switching off device or at least one of the switching off devices comprises at least one valve, in particular an automatic valve which, according to one embodiment, switches automatically when a corresponding stroke position of the hydraulic cylinder is being passed over, in particular as a result of a corresponding stroke position of the hydraulic cylinder being passed over, in order to interrupt the supply of energy to the first adjustment drive via the second reversing device. Accordingly, hydraulic pressure (or a hydraulic pressure supply) for (angular) adjustment of a rotor blade by its hydraulic adjustment drive is also referred to as (a pressure) energy (supply) in the sense of the present invention, and/or the term “energy” is intended to be understood to also refer, in particular, to drive energy for the adjustment drive, in particular, therefore, electrical energy for an electromotive adjustment drive or hydraulic pressure (energy) for a hydraulic adjustment drive. In other words, according to one embodiment, the word “energy” can be replaced by “(hydraulic) pressure” in the present application.

The present invention can be used for this purpose to particular advantage, in particular due to the robust traversing capabilities of such hydraulic rotor blade adjustment drives.

According to one embodiment, the rotor comprises at least one further rotor blade which can be adjusted in terms of its angle, and a further adjustment drive for adjusting this further rotor blade, wherein the adjustment can be carried out analogously to the adjustment which has been described herein with reference to the first rotor blade. In particular, one or more of the features which have been described herein with reference to the first rotor blade can also be implemented analogously in connection with the further rotor blade or in connection with one or more of the further rotor blades.

According to one embodiment, the further adjustment drive can be supplied with energy from the energy storage device via the second reversing device.

According to one embodiment, by means of this, the second reversing device can be used for specifying the directions of adjustment of two or more rotor blades, in particular for specifying the directions of adjustment of two or more rotor blades in a successive or sequential manner: for example, in particular, the directions of adjustment for the first rotor blade can first be specified by means of the second reversing device and then the first adjustment drive can be adjusted in the specified direction by controlling the switching off device in order to interrupt the supply of energy to the first adjustment drive, while the further adjustment drive is not supplied with energy by controlling a further switching off device for interrupting the supply of energy to the further adjustment drive via the second reversing device. Subsequently, the supply of energy to the first adjustment drive can be interrupted by means of the corresponding switching off device, the directions of adjustment for the further rotor blade can be specified by means of the second reversing device and then the further adjustment drive can be adjusted in this specified direction by controlling the further switching off device in order to interrupt the supply of energy to the further adjustment drive, while now the first adjustment drive is not supplied with energy.

According to one embodiment, the wind energy installation comprises the first reversing device for supplying energy to the first adjustment drive from the source of energy, and the second reversing device, which can be switched over by means of the safety control device/system, for supplying energy to the first adjustment drive from the energy storage device, as well as another reversing device for supplying energy to the further adjustment drive from the source of energy and/or a further reversing device, in particular a further reversing device which can be switched over by means of the same or an additional safety control device/system, for supplying energy to the further adjustment drive from the same energy storage device or from a further energy storage device.

According to one embodiment, by means of this, the safety can be improved.

In the event that at least one special operating case should occur, in particular in the event that at least one malfunction case should occur, according to one embodiment of the present invention, in order to operate the wind energy installation, the first rotor blade is adjusted in the first direction with the aid of the first adjustment drive which is supplied with energy from the energy storage device via the second reversing device in a first mode of operation of the first special mode of operation, in which the second reversing device is switched to the first switching position by means of the safety control device/system. According to one embodiment, in a second mode of operation of the first special mode of operation, in which the second reversing device is switched to the second switching position by means of the safety control device/system, the first rotor blade is adjusted in a second direction which is opposite to the first direction, i. e. in particular while the first special mode of operation is still ongoing, in particular while the malfunction case is still ongoing.

As has been described elsewhere, by means of this—in a deliberate departure from previous safety concepts with a single, fixed direction of adjustment for the special operating case or for the special mode of operation, in particular for a malfunction case—a blade angle control and/or resetting to a target position can, if necessary to a limited extent, also take place in such a special operating case or such a special mode of operation in an advantageous manner.

According to one embodiment, the safety control device/system switches the second reversing device one or more times from the first to the second switching position and/or one or more times from the second to the first switching position in the first special mode of operation.

According to one embodiment, by means of this, a blade angle control, which may possibly be restricted, can be realized or maintained in the first special mode of operation and, by means of this, in particular an energy yield of the wind energy installation can be improved.

According to one embodiment, the safety control device/system always switches the second reversing device back from the second to the first switching position in the first special mode of operation, or it is set up in this way or is set up for this purpose.

According to one embodiment, by means of this, the safety can be improved, since, by means of the safety control device/system, it is ensured that the first direction, which according to one embodiment corresponds to the fixed, single direction of previous safety concepts, is temporarily reversed only in a targeted manner and under the supervision of the safety control device/system. According to one embodiment, the first direction corresponds to a direction of approach to a feathered position of the first rotor blade, according to one embodiment from a normal operating position, in particular from a normal operating position which is energy-optimized, and/or on the shortest path or on the shorter of two possible paths.

According to one embodiment, in the first special mode of operation, the safety control device/system interrupts the supply of energy to the first adjustment drive via the second reversing device one or more times in (each of) the first mode of operation and/or in the second mode of operation, according to one embodiment before it switches the second reversing device from the first switching position to the second switching position and/or from the second switching position to the first switching position. According to one embodiment, in the first special mode of operation, the safety control device/system switches the second reversing device only when the supply of energy to the first adjustment drive has been interrupted. In addition or as an alternative, according to one embodiment, in the event of a switchover of the second reversing device, the safety control device/system does not activate the supply of energy to the first adjustment drive via the second reversing device in the first special mode of operation until after the second reversing device has been switched over.

In this way, the second reversing device only needs to guide the (supply of) energy, but is not placed under load by the closing or opening, for example by switching sparks, switching pressures or the like. By interrupting the supply of energy several times in the first or the second mode of operation, according to one embodiment the rotor blade can be adjusted in an advantageous manner in a stepwise fashion and can be controlled by means of this in an advantageous manner.

According to one embodiment, the first special mode of operation is carried out as a result of a malfunction in the supply of energy to the first adjustment drive from the source of energy via the first reversing device, in particular during a malfunction in the supply of energy to the first adjustment drive from the source of energy via the first reversing device, according to one embodiment as a result of a failure of the source of energy, in particular a power failure or a failure of a hydraulic source, in particular a failure of a hydraulic pump, and/or a functional malfunction of the first reversing device, in particular during a failure of the source of energy, in particular a power failure or a failure of a hydraulic source, in particular a failure of a hydraulic pump, and/or a functional malfunction of the first reversing device, wherein a functional malfunction of the first reversing device can in particular be a malfunction of the first reversing device itself, i. e. in particular a defect of a converter or a switching valve, or a malfunction of a (pitch) controller controlling the first reversing device.

For such cases, the present invention can be used to particular advantage, without being limited to this.

According to one embodiment, a deviation between a current position of the first rotor blade, in which a pitch brake or the pitch brake is closed in order to hold the rotor blade, and a predetermined target position is detected, wherein, if the deviation exceeds a predetermined threshold value, the first rotor blade is adjusted in the direction of the target position with the aid of the first adjustment drive which is supplied with energy from the energy storage device via the second reversing device.

As has already been explained, by means of this, according to one embodiment the pitch brake or the rotor blade can be secured in the target position, and, as a result of this, according to one embodiment the pitch brake can be designed to be weaker.

According to one embodiment, the first rotor blade is adjusted in the first direction with the aid of the first adjustment drive which is supplied with energy from the energy storage device via the second reversing device if (it has been determined that) the adjustment path from the detected current position to the target position is shorter in the first direction than in the second direction, and is adjusted in the second direction if (it has been determined that) the adjustment path from the current position to the target position is shorter in the second direction than in the first direction. In other words, according to one embodiment, the target position is approached on the shorter of two possible adjustment paths.

In this way, according to one embodiment, it is possible for the passing through of particularly unfavorable positions to be avoided.

According to one embodiment, the supply of energy to the first adjustment drive from the energy storage device is disconnected and, on the basis of at least one reactivating activation signal, is reconnected while the first special mode of operation is still being carried out.

According to one embodiment, by means of this, the safety can be improved, and in particular an unintentional actuation of the adjustment drive beyond a predefined stopping position or a predefined stopping region can be avoided. By means of the reconnection despite the fact that the special operating case or the special mode of operation is still ongoing, it is in this context possible to react, in an advantageous manner, to conditions and/or events that occur during the (still ongoing) special operating case or the special mode of operation.

For example, it may in particular be desirable to continue to adjust the rotor blade further from the stopping position which has been approached, even if the special operating case is still ongoing, for example manually by maintenance personnel, who can now variably move the rotor blade by reversing the direction of adjustment by means of the second reversing device.

If the pitch brake slips (through) during the special operating case or the special mode of operation, according to one embodiment it is possible to react to this in an advantageous manner by resetting with the aid of the adjustment drive.

According to one embodiment, a reactivating activation signal can be triggered by a manual input via at least one interface, and in particular a triggering of a reactivating activation signal becomes possible by a manual input via at least one interface, and in particular a triggering of a reactivating activation signal takes place by a manual input via at least one interface.

According to one embodiment, by means of this, it is possible for maintenance personnel to move the rotor blade with the aid of the adjustment drive and the energy storage device in the opposite direction during the special operating case which is still ongoing.

According to one embodiment, the at least one interface is arranged on the rotor, in particular in such a way that it is visible from the nacelle and/or in such a way that it can be reached from the nacelle, in particular manually.

According to one embodiment, by means of this, the safety can be improved, and in particular the reactivating activation signal can be triggered directly on site, preferably with visual contact.

According to one embodiment, the manual triggering is possible via two or more interfaces, which, according to one embodiment, are arranged on the rotor, in particular which are distributed along a circumference of the rotor, and which, according to one embodiment, are arranged on sides of the rotor which are opposite to one another.

According to one embodiment, by means of this, the safety can be improved, and in particular the reactivating activation signal can be triggered at different rotational positions of the rotor.

According to one embodiment, the manual triggering of the reactivating activation signal requires at least two manual inputs, according to one embodiment at least two sequential manual inputs, according to one embodiment at least two sequential manual inputs which are temporally spaced. According to one embodiment, first, a switch to a standby mode is made by means of a manual input at the interface or at at least one of the interfaces, according to one embodiment for a predetermined period of time, and, according to one embodiment, this is indicated, according to one embodiment at the interface or the interfaces, in particular by the interface or interfaces, and only when a further manual input is made during the standby mode is the supply of energy from the energy storage device for adjusting the rotor blade then switched on again and, according to one embodiment, this adjustment is also initiated. According to one embodiment, an interface comprises a button which is constructed in terms of hardware or software.

According to one embodiment, by means of this, the safety can be improved, and in particular the likelihood of an unintentional adjustment can be reduced.

According to one embodiment, one or more steps of the method, in particular all steps of the method, are carried out in a fully or partially automated manner, in particular by the wind energy installation, in particular by its control device/system.

According to one embodiment, the term “controlling” includes “controlling with feedback”.

According to one embodiment, the malfunction case is a grid failure or a malfunction case, in particular a defect of the wind energy installation, in the event of a grid failure, in particular during a grid failure, and/or in the first special mode of operation or in the malfunction case, the first and/or the further adjustment drive is disconnected from the source of energy, according to one embodiment from an (electricity) grid or from a hydraulic source or from a supply of hydraulic energy or from a hydraulic system or from a hydraulic grid, from which it is supplied with energy in normal operation (or in a normal mode of operation) or in regular operation (or in a regular mode of operation), or such a disconnection takes place, and/or is (instead), at least temporarily, supplied with energy from the (corresponding) energy storage device, in particular for adjustment, via the second or the further reversing device, and/or the supply of energy to the first adjustment drive and/or to the further adjustment drive is switched over from the source of energy to the (corresponding) energy storage device, or such a supplying or switching over takes place. According to one embodiment, the first special mode of operation is carried out as a result of this malfunction case, in particular during this malfunction case. According to one embodiment, the source of energy comprises an (electricity) grid or a hydraulic system or a hydraulic network or a hydraulic (pressure) source or a hydraulic (pressure) supply, and according to a further development, the source of energy is an (electricity) grid or a hydraulic system or a hydraulic network or a hydraulic (pressure) source or a hydraulic (pressure) supply.

According to one embodiment, a feathered position or the feathered position is a position which is at least substantially perpendicular with respect to an orientation for maximum power output, or which is rotated by at least 85 degrees and/or at most 95 degrees with respect to such an orientation (or such a normal orientation).

According to one embodiment, the first adjustment drive cannot be supplied with energy from the source of energy via the second reversing device in order to adjust the first rotor blade in the first direction or in the second direction, and/or the second reversing device is not set up to supply energy to the first adjustment drive from the source of energy in order to adjust the first rotor blade in the first direction or in the second direction, and/or the wind energy installation, in particular the second reversing device, is set up in such a way that the first adjustment drive cannot be supplied with energy from the source of energy via the second reversing device in order to adjust the first rotor blade in the first direction or in the second direction. In addition or as an alternative, according to one embodiment, the second reversing device can only be switched over by the safety control device/system. According to one embodiment, the further adjustment drive cannot be supplied with energy from the source of energy via the second reversing device or the further reversing device in order to adjust the further rotor blade, and/or the second reversing device or the further reversing device is not set up for supplying energy to the further adjustment drive from the source of energy in order to adjust the further rotor blade, and/or the wind energy installation, in particular the second reversing device or the further reversing device, is set up in such a way that the further adjustment drive cannot be supplied with energy from the source of energy via this second reversing device or the further reversing device in order to adjust the further rotor blade. In addition or as an alternative, according to one embodiment, the further reversing device can only be switched over by the safety control device/system. According to one embodiment, the second reversing device and/or the further reversing device is provided only for supplying the first adjustment drive or the further adjustment drive with energy from the (corresponding) energy storage device, and, in particular, the second reversing device and/or the further reversing device is set up only for supplying the first adjustment drive or the further adjustment drive with energy from the (corresponding) energy storage device. According to one embodiment, by means of this, the safety can be improved.

Further advantages and features will become apparent from the claims and the example embodiments.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a wind energy installation in accordance with an embodiment of the present invention;

FIG. 2 shows a portion of the wind energy installation; and

FIG. 3 shows a method of operating the wind energy installation in accordance with an embodiment of the present invention.

### DETAILED DESCRIPTION

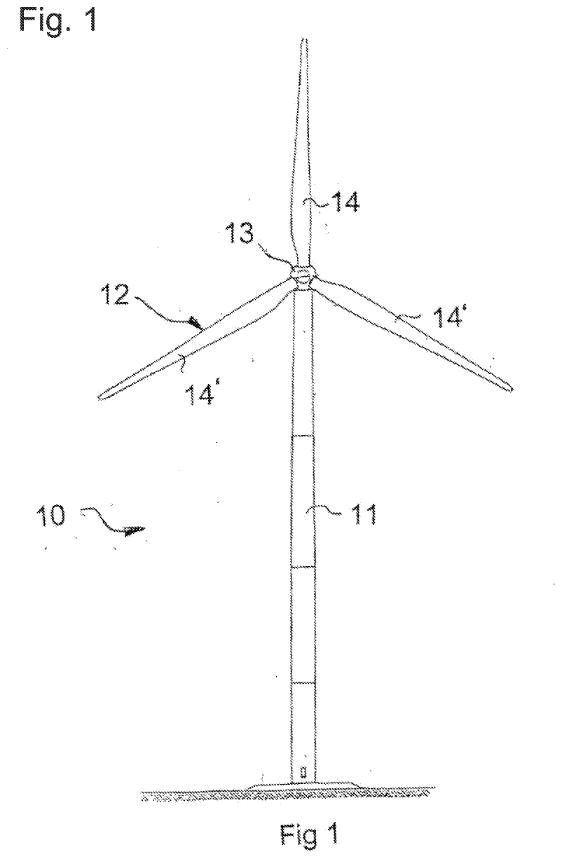

FIG. 1 shows a wind energy installation 10 in accordance with an embodiment of the present invention which comprises a tower 11, at the upper end of which a rotor 12 with a rotor hub 13 and three rotor blades is arranged.

The three rotor blades, of which an arbitrary one may be a first rotor blade 14 and each of the other two may be a further rotor blade 14′ within the meaning of the present invention, are individually adjusted (in terms of their angle) or rotated about their longitudinal axes by their own adjustment drives or, respectively, by their own adjustment drive, in particular between a zero position, in which they generate a maximum power, and a feathered position, in which they generate a minimum power, in particular no power, at the rotor axis of rotation or at the rotor hub.

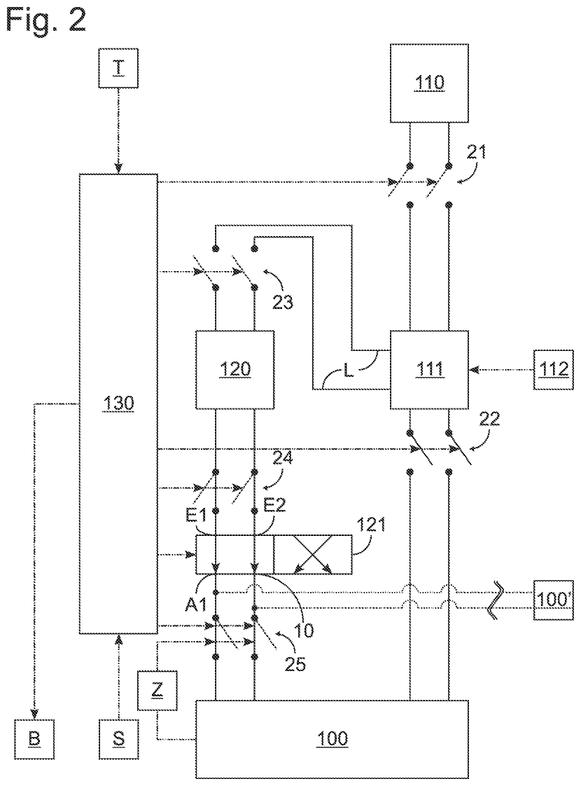

FIG. 2 shows the first adjustment drive 100 for adjusting the first rotor blade 14, which first adjustment drive may in particular be an electromotive adjustment drive or a hydraulic adjustment drive. The other adjustment drives 100′ for adjusting the further rotor blades 14′ can be constructed in an identical manner and can be operated in an identical manner.

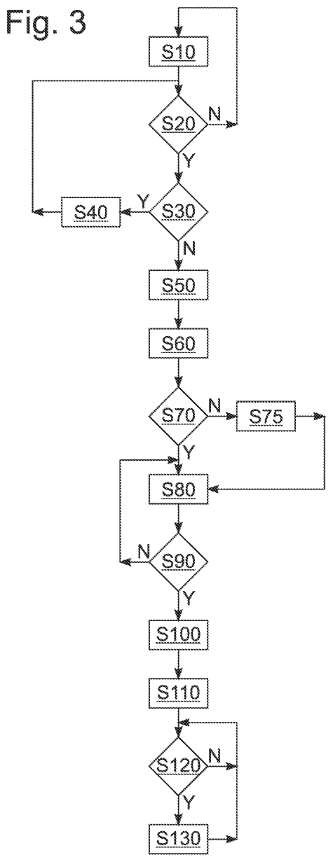

In a regular or a normal mode of operation, it is supplied with energy from a source of energy 110, in the example embodiment a grid or a hydraulic (pressure) source, via a first reversing device 111 which is controlled by means of a pitch controller 112 and which, in the example embodiment, comprises a converter or one or more switching valves (FIG. 3: step S10).

In the event of a power failure or a failure of the hydraulic (pressure) source (S20: “Y”), provided that the first reversing device 111 and the pitch controller 112 continue to function correctly (S30: “Y”), the adjustment drive 100 is supplied with energy from an energy storage device 120 via the first reversing device 111 instead of from the source of energy 110 (FIG. 3: Step S40—further special mode of operation).

For this purpose, corresponding switching devices 21, 23 are actuated, for example by means of a safety control device/system 130, in particular a connection between the source of energy 110 and the first reversing device 111 is interrupted (switching device 21 opened) and the first reversing device 111 is instead connected to the energy storage device 120 via lines L (switching device 23 closed).

If, on the other hand, there is a functional malfunction of the first reversing device 111, i. e. in particular a defect of the converter or of one of the switching valves or of the pitch controller 112 which controls the first reversing device 111 (S30: “N”), a first special mode of operation is carried out. According to a variation, this prioritized supply of energy from the energy storage device 120 via the (still functional—S30: “Y”) first reversing device 111 can also be omitted.

In the first special mode of operation, the safety control device/system 130 interrupts a connection between the first reversing device 111 and the adjustment drive 100 by means of switching device 22 (FIG. 3: step S50).

In addition, the safety control device/system 130 determines a desired direction of adjustment for the first rotor blade which is actuated by means of the adjustment drive 100, for example a first direction from the zero position (by the shortest path) to the feathered position in order to approach the feathered position, or an opposite, second direction, for example in order to return the rotor blade in a limited emergency mode of operation further in the direction of the zero position for the purpose of controlling the power of the wind energy installation, or in order to return, to the feathered position, the rotor blade that has slipped beyond the feathered position in the first direction (FIG. 3: step S60).

If the desired direction of adjustment is not the first direction (S70: “N”), the safety control device/system 130 switches a second reversing device 121, in the example embodiment a contactor or a multi-way switching valve, from its first switching position shown in FIG. 2 over to a second switching position (S75), and otherwise (S70: “Y”) the second reversing device 121 remains in its first switching position.

In the first switching position, the second reversing device 121 connects a first input E1 to a first output A1, as well as a second input E2 to a second output A2; conversely, in the second switching position, the second reversing device 121 connects the first input E1 to the second output A2, as well as the second input E2 to the first output A1.

Then, the safety control device/system 130 closes a switching off device 24 so that the adjustment drive 100 adjusts the first rotor blade in the corresponding direction (FIG. 3: step S80). This is the condition shown in FIG. 2 (in solid lines).

When this reaches the feathered position (S90: “Y”), this opens a further switching off device 25, in the example embodiment a contactor or an automatic switching valve, and the power supply is interrupted with a time delay by means of a time delay device Z (FIG. 3: step S100). In a variation not shown, the further switching off device 25 can also be replaced by a mechanical (end) stop, in particular in the case of hydraulic adjustment drives.

The safety control device/system 130 opens the switching off device 24 and, if applicable, switches the second reversing device 121 back to the first switching position (FIG. 3: step S110).

It then monitors a position of the rotor blade by means of sensors S.

If this moves too far away from the feathered position despite the pitch brake B being closed (S120: “Y”), the safety control device/system 130 determines the first direction as the desired direction of adjustment if the adjustment path from the current position to the feathered position is shorter in the first direction than in the second direction, and determines the second direction as the desired direction of adjustment if the adjustment path from the current position to the feathered position is shorter in the second direction than in the first direction, and then adjusts the rotor blade back to the feathered position by controlling the switching off device 24 accordingly (FIG. 3: Step S130).

In an analogous manner, in the first special mode of operation, the safety control device/system 130 can also adjust the rotor blade, for example, to a desired position between the zero position and the feathered position, or to the zero position, in order to carry out a (limited) power control of the wind energy installation by first determining the direction of adjustment which is required or desired for this purpose, as has been described above, switching the second reversing device 121 over if necessary, and then controlling the switching off device 24 accordingly.

If maintenance personnel enters a request for a particular movement via a button T or the like, the safety control device/system 130 can also implement this in the first special mode of operation in an analogous manner; for example, if a request for movement in the second direction is entered it can switch the second reversing device 121 over and subsequently close the switching off device 24 as long as a corresponding active input is detected via the button T; and if a request for movement in the first direction is input, it can close the switching off device 24 as long as a corresponding active input is detected via the button T, since the second reversing device 121 has always been switched back to the first switching position.

As is indicated by dashed lines, a further adjustment drive 100′ for adjusting a further one of the rotor blades 14′ can also be controlled in an analogous manner by the safety control device/system 130 with the aid of the second reversing device 121.

In a variation not shown, a further reversing device is instead provided for the further adjustment drive 100′, with the aid of which further reversing device the further adjustment drive 100′ for adjusting the further rotor blade 14′ is controlled by the safety control device/system 130 in the same way as has been described above for the first adjustment drive 100 and the second reversing device 121 (which, according to one embodiment, is then only responsible for the first adjustment drive 100).

Although example embodiments have been explained in the preceding description, it is to be noted that a variety of variations are possible. In addition, it is to be noted that the example embodiments are merely examples which are not intended to limit the scope of protection, the applications and the structure in any way. Rather, the preceding description provides the person skilled in the art with a guideline for the implementation of at least one example embodiment, whereby various modifications, in particular with regard to the function and the arrangement of the components described, can be made without departing from the scope of protection as it results from the claims and combinations of features equivalent to these.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SKINS

10 wind energy installation
11 tower
12 rotor
13 hub
14 first rotor blade
14′ further rotor blade
20-25 switching off device
100 first adjustment drive
100′ further adjustment drive
110 source of energy
111 first reversing device
112 pitch controller
120 energy storage device
121 second reversing device
130 safety control device/system
A1 first output
A2 second output
B pitch brake
E1 first input
E2 second input
L line
S sensor
T button
Z time delay device

What is claimed is:

1-16. (canceled)

17. A wind energy installation, comprising:
a rotor with a first rotor blade that is adjustable in terms of its angle;
a first adjustment drive configured for adjusting the first rotor blade;
a first reversing device configured for supplying energy to the first adjustment drive from an energy source via the first reversing device in order to adjust the first rotor blade in a first direction, and for supplying energy to the first adjustment drive from the energy source via the first reversing device in order to adjust the first rotor blade in a second direction that is opposite to the first direction;
a second reversing device configured for supplying energy to the first adjustment drive from a first energy storage device in a first special mode of operation via the second reversing device in a first switching position in order to adjust the first rotor blade in the first direction, and for supplying energy to the first adjustment drive from the first energy storage device in the first special mode of operation via the second reversing device in a second switching position in order to adjust the first rotor blade in the second direction; and
a safety control device/system configured to switch over the second reversing device from the first switching position to the second switching position.

18. The wind energy installation of claim 17, further comprising:
at least one switching off device configured for interrupting the supply of energy to the first adjustment drive via the second reversing device.

19. The wind energy installation of claim 18, wherein at least one of:
the at least one switching off device is controlled by the safety control device/system; or
the at least one switching off device is configured to interrupt the supply of energy to the first adjustment drive in response to a predetermined stopping position or a predetermined stopping region of the first rotor blade having been reached.

20. The wind energy installation of claim 19, further comprising a time delay device configured for causing at least a predetermined waiting time between a detection of a predetermined position of the first rotor blade and the interruption of the supply of energy by means of the switching off device.

21. The wind energy installation of claim 17, further comprising at least one line configured for supplying energy to the first adjustment drive from the first energy storage device via the first reversing device in at least one second special mode of operation.

22. The wind energy installation of claim 17, further comprising:
a pitch brake configured for holding the first rotor blade in a current position; and
a detection device configured for detecting a deviation between a current position of the first rotor blade and a predetermined target position;
wherein the safety control device/system is configured to adjust the first rotor blade in the direction of the target position with the adjustment drive supplied with energy from the first energy storage device via the second reversing device in response to the deviation exceeding a predetermined threshold value.

23. The wind energy installation of claim 22, wherein the pitch brake is configured to slip at a load acting on the first rotor blade that is smaller than a maximum design load acting on the first rotor blade in a feathered position of the first rotor blade.

24. The wind energy installation of claim 17, wherein at least one of:
the second reversing device:
connects a first input to a first output, and connects a second input to a second output in the first switching position, and
connects the first input to the second output, and connects the second input to the first output in the second switching position; or
the first adjustment drive comprises:
at least one electric motor and the first energy storage device comprises at least one electrical energy storage device, or
at least one hydraulic actuator and the first energy storage device comprises at least one pressure accumulator.

25. The wind energy installation of claim 17, further comprising:
at least one second rotor blade on the rotor and adjustable in terms of its angle;
a second adjustment drive configured for adjusting the second rotor blade;
wherein the second adjustment drive is configured to be supplied with energy from the first energy storage device or from a second energy storage device, different than the first energy storage device, via the second reversing device or via a further reversing device.

26. A method of operating a wind energy installation, the wind installation including a rotor with a first rotor blade that is adjustable in terms of its angle, and a first adjustment drive configured for adjusting the first rotor blade in a first direction or a second direction opposite the first direction, the method comprising:
in response to the occurrence of a special mode of operation, supplying energy for adjusting the first rotor blade to the first adjustment drive from a first energy storage device via a second reversing device; and
in a first mode of the special mode of operation:
switching the second reversing device to a first switching position with the safety control device/system,
wherein the second reversing device supplies energy to the first adjustment drive from the first energy storage device in the first switching position to adjust the first rotor blade in the first direction.

27. The method of claim 26, wherein the at least one special operating case is at least one malfunction case.

28. The method of claim 26, wherein the method is carried out on a wind energy installation comprising:
a rotor with a first rotor blade that is adjustable in terms of its angle;
a first adjustment drive configured for adjusting the first rotor blade;
a first reversing device configured for supplying energy to the first adjustment drive from an energy source via the first reversing device in order to adjust the first rotor blade in a first direction, and for supplying energy to the first adjustment drive from the energy source via the first reversing device in order to adjust the first rotor blade in a second direction that is opposite to the first direction;
a second reversing device configured for supplying energy to the first adjustment drive from a first energy storage device in a first special mode of operation via the second reversing device in a first switching position in order to adjust the first rotor blade in the first direction, and for supplying energy to the first adjustment drive from the first energy storage device in the first special mode of operation via the second reversing device in a second switching position in order to adjust the first rotor blade in the second direction; and
a safety control device/system configured to switch over the second reversing device from the first switching position to the second switching position.

29. The method of claim 26, further comprising:
in a second mode of the special mode of operation:
switching the second reversing device to a second switching position with the safety control device/system,
wherein the second reversing device supplies energy to the first adjustment drive from the first energy storage device in the second switching position to adjust the first rotor blade in the second direction.

30. The method of claim 29, wherein at least one of:
in the first mode of the special mode of operation, the safety control device/system at least one of:
switches the second reversing device one or more times over from the first switching position to the second switching position, or
switches the second reversing device one or more times from the second switching position to the first switching position;
in the first mode of the special mode of operation, the safety control device/system always switches the second reversing device back from the second switching position to the first switching position;
in the first mode of the special mode of operation, the safety control device/system interrupts the supply of energy to the first adjustment drive via the second reversing device one or more times in at least one of the first mode or the second mode of the special mode of operation; or
in the first mode of the special mode of operation, in the case of a switchover of the second reversing device, the safety control device/system only activates the supply of energy to the first adjustment drive via the second reversing device after the second reversing device has been switched over.

31. The method of claim 30, wherein the safety control device/system interrupts the supply of energy to the first adjustment drive in at least one of the first mode or the second mode of the special mode of operation at least one of:
before switching the second reversing device over from the first switching position to the second switching position; or
before switching the second reversing device over from the second switching position to the first switching position

32. The method of claim 26, wherein at least one of:
the first special mode of operation is carried out as a result of a malfunction in the supply of energy to the first adjustment drive from the source of energy via the first reversing device;
the first special mode of operation is carried out during a malfunction in the supply of energy to the first adjustment drive from the source of energy via the first reversing device; or
the first special mode of operation is carried out as a result of at least one of a failure of the source of energy or a functional malfunction of the first reversing device.

33. The method of claim 26, further comprising:
detecting a deviation between a current position of the first rotor blade, in which a pitch brake is closed in order to hold the rotor blade, and a predetermined target position; and
adjusting the first rotor blade in the direction of the target position with the first adjustment drive in response to the detected deviation exceeding a predetermined threshold value, wherein the first adjustment drive is supplied with energy from the first energy storage device via the second reversing device.

34. The method of claim 33, further comprising:
adjusting the first rotor blade in the first direction if the adjustment path from the current position to the target position is shorter in the first direction than in the second direction; and
adjusting the first rotor blade in the second direction if the adjustment path from the current position to the target position is shorter in the second direction than in the first direction.

35. The method of claim 26, further comprising:
disconnecting the supply of energy to the first adjustment drive from the energy storage device; and
in response to at least one reactivating activation signal, reconnecting the supply of energy to the first adjustment drive from the energy storage device while the first special mode of operation is still being carried out.

36. A computer program product for operating a wind energy installation, the wind installation including a rotor with a first rotor blade that is adjustable in terms of its angle, and a first adjustment drive configured for adjusting the first rotor blade in a first direction or a second direction opposite the first direction, the computer program product comprising program code stored on a non-transitory, computer-readable medium, the program code configured, when executed on a computer, to cause the computer to:
in response to the occurrence of a special mode of operation, supply energy for adjusting the first rotor blade to the first adjustment drive from a first energy storage device via a second reversing device; and
at least one of:
in a first mode of the special mode of operation:
switch the second reversing device to a first switching position with the safety control device/system,
wherein the second reversing device supplies energy to the first adjustment drive from the first energy storage device in the first switching position to adjust the first rotor blade in the first direction, or
in a second mode of the special mode of operation:
switch the second reversing device to a second switching position with the safety control device/system,
wherein the second reversing device supplies energy to the first adjustment drive from the first energy storage device in the second switching position to adjust the first rotor blade in the second direction.
